(19) United States
(12) Patent Application Publication
(10) Pub. No.: US 2025/0368899 A1
(43) Pub. Date: Dec. 4, 2025

(54) BIOMASS OLEOTHERMAL LIQUEFACTION PROCESS

(71) Applicant: UOP LLC, Des Plaines, IL (US)

(72) Inventor: Christopher J. Keturakis, Arlington Heights, IL (US)

(21) Appl. No.: 19/088,908

(22) Filed: Mar. 24, 2025

Related U.S. Application Data
(60) Provisional application No. 63/652,587, filed on May 28, 2024.

(51) Int. Cl. C10G 1/00

(52) U.S. Cl. CPC C10G 1/002; C10G 2300/1011

(57) ABSTRACT

A process for upgrading a biomass feed stream comprises liquefaction and deoxygenation in one step. The process comprises reacting the biomass feed stream over a catalyst in the presence of hydrogen in a reactor to produce a reactor effluent stream. The reactor effluent stream is separated to provide a liquid effluent stream comprising bio-oil. An oil stream is added to the reactor in an oil to biomass weight ratio of less than about 2:1. A bio-oil stream is taken from the liquid effluent stream. The bio-oil stream may be processed to produce one or more fuel streams.

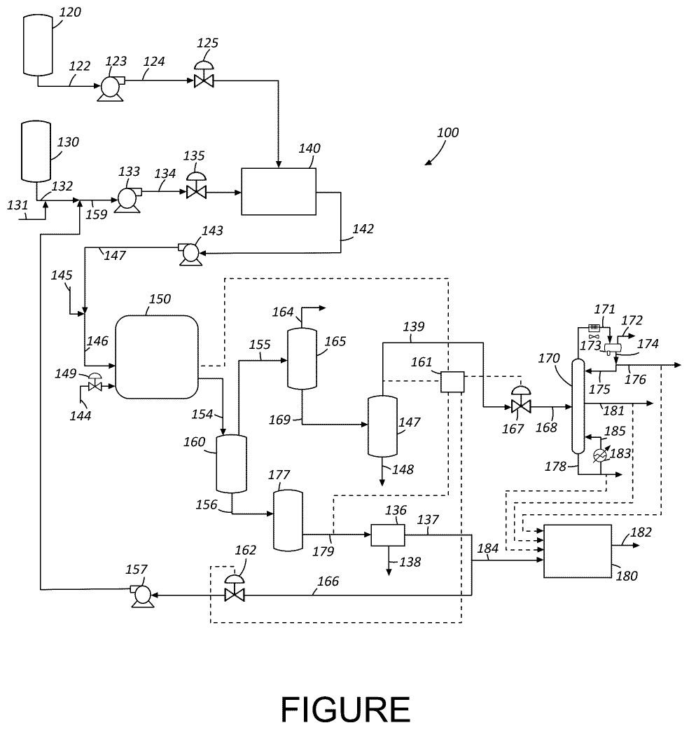

### FIELD

The field is related to a process for upgrading a biomass feed stream. Particularly, the field relates to a process for upgrading a biomass feed stream in oil.

### BACKGROUND

With the growing energy consumption worldwide and the emissions associated with the non-renewable energy sources, use of renewable energy sources is becoming increasingly important for the production of liquid fuels. These fuels from biological sources are often referred to as biofuels.

One prominent renewable energy source is the use of biomass in the generation of biofuels and other bioproducts of industrial interest. Biomass can be converted into biofuels and associated products through various processes such as thermal, physicochemical and biological processes. However, all of these process have some difficulties in terms of efficiency and product yields that prevent, in many cases, their economic sustainability.

Biomass which may comprise cellulosic materials may be converted into valuable intermediates, which may be further processed into fuel components. Cellulosic biomass is of considerable interest as feedstock for the production of sustainable biofuels. Biofuels are combustible fuels which can be derived from biological sources. The use of such biofuels results in reduction of greenhouse gas emissions. Biofuels can be used for blending with conventional petroleum derived fuels.

Liquefaction is one of the processes that converts biomass into a bio-oil or biocrude with a high energy densification. Bio-oil or biocrude can be subjected to combustion or further refined to obtain liquid fuels with higher value such as diesel and gasolines. Particularly, bio-oils can be obtained by thermochemical liquefaction, notably pyrolysis, such as flash, fast, slow or catalytic pyrolysis. Pyrolysis is a thermal decomposition process in the absence of oxygen with thermal cracking of the feedstocks to gas, liquid and solid products. A catalyst can be added to enhance the conversion in the catalytic pyrolysis. Various technologies have been deployed for large scale biomass pyrolysis. They include bubbling fluidized beds, circulating fluidizing beds, ablative pyrolysis, vacuum pyrolysis, and rotating cone pyrolysis reactors. Catalytic pyrolysis generally produces a bio-oil having a lower oxygen content than bio-oil obtained by thermal decomposition. The selectivity between gas, liquid and solid is well related to the reaction temperature and vapor residence time. Lower temperature around 400° C. and longer residence time for a few minutes to a few hours, obtained by slow pyrolysis, favors the production of solid product, also called char or charcoal, with typically almost equal portions of gas, liquid and char. Very high temperatures above 800° C. used in the gasification processes favors gas production typically more than 85 wt %. Intermediate reaction temperature typically about 450° C. to about 550° C. and short vapor residence time typically about 10 to about 20 s, for the intermediate pyrolysis, favor liquid yield such as producing half liquid. Intermediate reaction temperature typically about 450° C. to about 550° C. and very short vapor residence time typically about 1 to about 2 sec for the so-called flash pyrolysis or fast pyrolysis, favor even more the liquid yield typically up to 75 wt %.

Bio-oils can be processed to provide low-cost renewable liquid fuels for boilers, as well as for stationary gas turbines and diesels. Furthermore, fast pyrolysis has been demonstrated at fairly large scales of the order of several hundred tons per day. Nevertheless, there has not been any significant commercial uptake of this technology. The reasons may relate mostly to the poor physical and chemical properties of bio-oils in general and fast pyrolysis bio-oils in particular. For example, some of the undesirable properties of pyrolysis bio-oils may include: (1) corrosivity on account of their high water and acidic content; (2) relatively low specific calorific value on account of the high oxygen content, which typically is around 40% by mass; (3) chemical instability on account of the abundance of reactive functional groups like the carbonyl group and phenolic groups that can lead to polymerization on storage and consequent phase separation; (4) relatively high viscosity and susceptibility to phase separation under high shear conditions, for instance in a nozzle; (5) incompatibility with, on account of insolubility in, conventional hydrocarbon based fuels; and (6) blockage in nozzles and pipes caused by adventitious char particles, which will always be present in unfiltered bio-oil to some degree.

Hydrothermal liquefaction (HTL) is a decomposition process that works at reactor conditions that cause a supercritical water phase. The reactor conditions for the supercritical water phase typically include a pressure equal to or greater than about 22 MPa (3190 psi), a temperature of about 374° C. temperature, and a water-to-biomass ratio of typically equal to or greater than 2:1. The supercritical water phase, added as free water or a recycle aqueous phase, along with a typical alkali metal catalyst, is used to liquefy the biomass into bio-oil. The hydrothermally liquefied bio-oils suffer from the same undesirable properties as mentioned above for other pyrolysis bio-oils. Supercritical water under typical HTL conditions may be advantageous due to a higher density, a reduced dielectric constant making water a non-polar solvent, and a high self-ionization of water (typically expressed as the ionic product) that favors ionic reactions over radical reactions which can cause coke formation. Hydrothermal liquefaction can also be performed under subcritical water reaction conditions such as about 5 MPa (725 psi) to about 22 MPa (3190 psi) and about 250° C. to about 350° C. and provides similar benefits. The balance between the temperature and pressure is key to achieving the benefits mentioned above, however, the higher temperatures of the supercritical HTL regime allow for faster reaction kinetics which may help overcome mass transfer limited reactions at lower temperatures. Typically, HTL processes utilize a homogeneous alkali metal catalyst, such as NaOH or KOH, which is soluble in an aqueous phase and promotes the depolymerization of biomass. C. Jensen, “Fundamentals of Hydrofaction: Renewable Crude Oil from Woody Biomass”, 7 Biomass Conv. Bioref., 495 (2017); H. Shahbeik, “Biomass to Biofuels using Hydrothermal Liquefaction: A Comprehensive Review”, 189 Renew. Sustain. Energy Rev., 113976 (2024).

All these aspects combine to render handling, shipping, storage and usage of conventional bio-oils difficult and expensive.

The economic viability of bio-oil production for fuel or energy applications therefore depends on finding appropriate methods to upgrade it to a higher quality liquid fuel at a sufficiently low cost.

Over the last two decades, the approach of direct hydroprocessing of bio-oil to convert it to stable oxygenates or hydrocarbons has been studied intensively. Conversion of biomass such as lignocellulosic biomass to renewable fuels is typically a multi-step process where biomass is first converted to an unstable bio-oil or biocrude via pyrolysis or hydrothermal liquefaction process. This unstable biocrude oil slowly polymerizes due to oxygen-containing functional groups, even at room temperature, and can turn solid within short time span such as months. Biocrude is then typically upgraded to a more stable oil via an upgrading process. The propensity to polymerize under heating ultimately forms extraneous solids or coke with consequences of reactor plugging and catalyst deactivation. If biomass could be converted to a stable, drop-in ready biocrude in fewer steps it would simplify the capital expense and challenges associated with storing, transporting, and upgrading an unstable biocrude oil.

Therefore, there is a need for an improved process for upgrading a biomass that minimizes the formation of solids and catalyst deactivation and provides an upgraded bio-oil product that can be used for producing useful fuels.

### SUMMARY

The present disclosure provides a process for upgrading a biomass feed stream. The process comprises deoxygenating the biomass feed stream over a catalyst in the presence of hydrogen in a reactor to produce a reactor effluent stream. An oil stream is added to the reactor to enable the catalyst to catalyze the breakdown of the biomass in the oil phase. The reactor effluent stream is separated to provide a liquid effluent stream comprising upgraded bio-oil. The upgraded bio-oil may be separated from the liquid effluent stream.

The reaction conditions in the reactor of the present process may include the presence of some water which is pre-existing within the biomass but not added free water or a separate recycled aqueous phase.

Preferably, the biomass feed stream comprises a non-aqueous feed stream. The present process utilizes a pressure comparable to subcritical HTL, but a higher temperature comparable to supercritical HTL and comprises an oil phase with catalyst for liquefaction of the biomass in the reactor. The higher temperature and oil phase of the present process enable a more active deoxygenation catalyst in the oil phase. Additionally, at the higher temperature, the catalyst is active in the oil phase which would otherwise be less active at the lower reaction temperatures of conventional subcritical aqueous liquefaction processes. Moreover, the catalyst may be recycled in a recycle oil while staying active at higher temperatures. Fresh catalyst may be continuously added into the reactor to maintain consistent deoxygenation. The presence of a deoxygenation catalyst, rather than typical HTL alkali metal catalysts, results in an upgraded bio-oil product that contains very little or no bad actor oxygen-containing functional groups such as aldehydes, ketones, and carboxylic acids, that cause bio-oil instability and polymerization.

### BRIEF DESCRIPTION OF THE DRAWINGS

FIGURE illustrates a schematic diagram of the process for upgrading a biomass feed stream in accordance with an exemplary embodiment of the present disclosure.

### DEFINITIONS

As used herein the terms “reactor”, “process equipment,” “process units,” or “reactor components” shall include any and all process equipment and process units that are utilized in hydrocarbon conversion processes including any upstream and/or downstream equipment from the particular unit and/or ancillaries, such as furnace tubes, associated piping, heat exchangers, heater tubes, and the like.

As used herein, the term “predominant” or “predominate” or “predominance” means greater than 50%, suitably greater than 75% and preferably greater than 90%.

As used herein, the term “carbon number” refers to the number of carbon atoms per hydrocarbon molecule and typically a paraffin molecule.

As used herein, the term “biomass” includes an organic matter derived from a biological process, which can be used as an energy source.

As used herein, the term “cellulosic material” refers to a material containing cellulose. Preferably the “cellulosic material” may be a “lignocellulosic material”. A “lignocellulosic material” comprises lignin, cellulose and optionally hemicellulose.

As used herein, “petroleum stream” may refer to crude oil, crude oil refinery distillates, crude oil refinery residue, cracked products or hydrocarbons from a crude oil refinery, liquefied coal, bitumen, typically extracted from the ground or sea floor.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T10” or “T90” means the temperature at which 10 mass percent or 90 mass percent, as the case may be, respectively, of the sample boils using ASTM D-86 or TBP.

As used herein, the term “vacuum gas oil” (VGO) includes hydrocarbons having an initial boiling point above about 343° C. (650° F.), with a T10 boiling point temperature using ASTM D1160 of about 370° C. (698° F.) and a T90 boiling point temperature using ASTM D1160 of about 500° C. (932° F.).

As used herein, the term “stable oil” means an upgraded oil having the desired concentration of functional groups or properties that make it useful directly as a fuel or to produce an intermediate blend or fuel stream that can be transported or processed in a refinery process unit.

As used herein, the terms “mol % H” and “mol % C” refer to the percentage of moles of hydrogen or carbon atoms, respectively, of the total moles of hydrogen or carbon atoms in oil. For example, if the bio-oil composition contains 5 moles of hydrogen atoms and 10 moles of carbon atoms and it is said that the bio-oil contains 10 mol % H of aldehydes and 20 mol % C of carboxylic acids and esters it means that 0.5 moles of hydrogen atoms in the bio-oil correspond to H atoms of molecules with an aldehyde functional group and 2 moles of carbon atoms in the bio-oil correspond to C atoms of molecules with either a carboxylic acid or ester functional group.

As used herein, the term “deoxygenation” may be used as a generic term to include any type of deoxygenation chemistry, such as hydrodeoxygenation, where hydrogen gas helps to remove oxygen to form water, or deoxygenation in the form of decarbonylation, decarbonxylation, or other chemical mechanisms.

As used herein, the terms “acid number” and “carboxylic acid number” are used interchangeably.

### DETAILED DESCRIPTION

Biocrude or bio-oil polymerization during deoxygenation or hydrotreating reactions is a major challenge when attempting to convert bio-oil to fuels. The present disclosure provides a process to upgrade a biomass-based feed in a preferably non-aqueous environment and a specific recycle stream to produce an upgraded bio-oil. The upgraded bio-oil can be used directly as fuel oil such as marine fuel. Alternatively, the upgraded bio-oil can be used as a feed stock for an FCC unit, a hydroprocessing unit, or a reforming unit to produce an intermediate blend or fuel. A fuel oil stream can be taken from the upgraded bio-oil stream. The upgraded bio-oil stream can be used directly to produce an intermediate blend or fuel. The upgrading process may include various analyses such as to generate spectroscopy data to identify molecular functional groups that are responsible for bio-oil polymerization. A stream may be taken from the upgraded bio-oil stream and analyzed to measure the concentration of selected constituents and compared to predetermined ranges. If the measured values fall within a predetermined range, the upgraded bio-oil stream can be used directly as fuel or charged to an FCC unit, a hydroprocessing unit, reforming unit, or other downstream processing unit to produce one or more intermediate blends and fuels. Identification and tracking of functional group evolution as a function of catalyst or process conditions helps in targeting the groups responsible for rapid polymerization and charring. These groups can be selectively eliminated to enhance the performance of the upgrading process. As described later in detail, the process comprises converting the oxygenate groups present in the feed, for example, to control charring potential. A recycle stream may be recycled to the reactor to offset a petroleum feed stream

Bio-oil is a complex mixture of compounds, including oxygenates, that are obtained from the breakdown of biopolymers in biomass. Bio-oils can be derived from biomass such as grasses and trees, wood chips, chaff, grains, grasses, corn, corn husks, weeds, aquatic plants, hay and other sources of lignocellulosic material, such as derived from municipal waste, food processing wastes, forestry wastes and cuttings, energy corps, or agricultural and industrial wastes such as sugar cane bagasse, oil palm wastes, sawdust or straws. Bio-oils can also be derived from pulp and paper by products whether they are recycled or not.

Bio-oil is a highly oxygenated, polar hydrocarbon product that typically contains at least about 10 mass % oxygen, typically about 10 to 60 mass % oxygen, more typically about 40 to about 50 mass % oxygen. In general, the oxygenates in the bio-oil may include alcohols, aldehydes, ketones, acetates, ethers, esters, organic acids, and naphthenic and aromatic (cyclic) oxygenates. Some of the oxygen is present as free water which may constitute at least about 10 mass %, typically about 25 mass % of the bio-oil. These properties render bio-oil totally immiscible with fuel grade hydrocarbons, even with aromatic hydrocarbons, which typically contain little or no oxygen.

In an aspect of the present disclosure, the biomass feed stream is upgraded to produce a bio-oil stream having a reduced concentration of oxygenates. The bio-oil stream may be processed to produce one or more fuel streams.

The biomass feed stream in the present disclosure may contain other oxygenates derived from biomass such as vegetable oils or animal fat derived oils. Vegetable oil or animal fat derived oil comprises fatty matter and therefore corresponds to a natural or elaborate substance of animal or vegetable origin, mainly containing triglycerides. Fat derived oil essentially involves oils from renewable resources such as fats and oils from vegetable and animal resources such as lard, tallow, fowl fat, bone fat, fish oil and fat of dairy origin, as well as the compounds and the mixtures derived therefrom, such as fatty acids or fatty acid alkyl esters. The products resulting from recycling animal fat and vegetable oils from the food processing industry can also be used, pure or in admixture with other constituent classes just described. The preferred feeds may comprise vegetable oils from oilseed such as rape, crucic rape, soybean, jatropha, sunflower, palm, copra, palm-nut, arachidic, olive, corn, cocoa butter, nut, linseed oil or oil from any other vegetable. These vegetable oils very predominantly consist of fatty acids in form of triglycerides, generally above 97% by mass, having long alkyl chains ranging from 8 to 24 in carbon number, such as butyric fatty acid, caproic, caprylic, capric, lauric, myristic, palmitic, palmitoleic, stearic, oleic, linoleic, linolenic, arachidic, gadoleic, eicosapentaenoic (EPA), behenic, crucic, docosahexacoic (DHA) and lignoceric acids. The fatty acid salt, fatty acid alkyl ester and free fatty acid derivatives such as fatty alcohols that can be produced by hydrolysis, by fractionation or by transesterification for example of triglycerides or of mixtures of these oils and of their derivatives also come within the definition of the “oil of vegetable or animal origin” feed in the present disclosure. All products or mixtures of products resulting from the thermochemical conversion of algae or products from the hydrothermal conversion of lignocellulosic biomass or algae in the presence of a catalyst or not or pyrolytic lignin are also feeds that can be used.

Moreover, the biomass feed stream can be coprocessed with petroleum and/or coal derived hydrocarbon feedstocks. The petroleum derived hydrocarbon feed stock can be straight run vacuum distillates, vacuum distillates from a conversion process such as those from coking, from fixed bed hydroconversion or from ebullated bed or slurry hydrocracking heavy fraction hydrotreatment processes, or from solvent deasphalted oils. The feeds can also be formed by mixing those various fractions in any proportions in particular deasphalted oil and vacuum distillate. They can also contain products from the fluid catalytic cracking units, such as light cycle oil (LCO) of various origins, heavy cycle oil (HCO) of various origins and any distillate fraction from fluid catalytic cracking generally having a distillation range of about 150° C. to about 370° C. They may also contain aromatic extracts and paraffins obtained from the manufacture of lubricating oils. The coal derived hydrocarbon feedstock can be products from the liquefaction of coal. Aromatics fractions from coal pyrolysis or coal gasification can also be used as a components of the biomass feed.

Referring to the FIGURE, an exemplary embodiment of a process 100 for upgrading a biomass feed stream is shown. A biomass feed stream is taken in line 122 from a biomass source, for example, a biomass storage drum 120. The biomass feed stream in line 122 may be passed to a mixer 140. Perhaps the biomass feed stream in line 122 may be pumped via a pump 123 and a pumped biomass feed stream in line 124 is passed to the mixer 140. In an aspect, the pump 123 is a sludge pump or a solid phase pump. A control valve 125 may be provided on the feed line 124 for maintaining a required flow rate of the bio-oil stream to the mixer 140.

Biomass in the biomass feed stream may include, but is not limited to, biological material or material of biological origin. Biomass as used throughout the remainder of this document, comprises three principle biopolymers: cellulose, hemicellulose, and lignin. The ratio of these three components varies depending on the biomass source. Cellulosic biomass might also contain lipids, ash, and protein in varying amounts.

The biomass feed stream in line 122 may comprise cellulose, or hemicellulose or a mixture thereof. The cellulose may be obtained from a variety of plants and plant materials including agricultural wastes, forestry wastes, sugar processing residues and/or mixtures thereof. Suitable cellulosic biomass may include but is not limited to agricultural wastes such as corn stover, soybean stover, corn cobs, rice straw, rice hulls, oat hulls, corn fiber, cereal straws such as wheat, barley, rye and oat straw; grasses; forestry products such as wood and wood-related materials such as sawdust; waste paper; sugar processing residues such as bagasse and beet pulp; or mixtures thereof.

In an embodiment, the biomass feed stream in line 122 may comprise lignin with cellulose. The lignocellulosic biomass may include but is not limited to rice husks, pine wood, oil palm, acacia wood, wood paulownia or any similar lignocellulosic biomass.

In an embodiment, the biomass feed stream in line 122 may comprise microalgae. The microalgae may include the genera anabaena, chlorella, chlorophyta, cryptophyta, dictyosphaerium, dinophyta, euglena, glaucophyta, haematococcus, hydrodictyon, microcystis, nodularia, oscillatoria, phacophyta, rhodophyta, scenedesmus, spirogyra, spirulina and tribophyt.

The biomass feed stream in line 122 may comprise some water pre-existing in the biomass. The biomass feed stream in line 122 may comprise a wet biomass having about 5 wt % to about 50 wt % water, or about 10 wt % to about 30 wt % water. In a preferred embodiment, the biomass in the biomass feed stream in line 122 may comprise less than about 5 wt % water. Moreover, the biomass is not pyrolyzed biomass but preferably is chemically untreated biomass. Chemically untreated biomass may comprise biomass that does not undergo a treatment step using chemicals external to the biomass, such as solvents, oils, catalysts, acids, and bases, that alter the chemical structure of the components of cellulose, hemicellulose, lignin, and their monomers. However, the chemically untreated biomass may be treated with thermal or mechanical processes which may comprise drying, torrefaction, steam explosion, particle size reduction, densification and/or pelletization of the biomass. The biomass may be subjected to particle size reduction, for example by maceration, crushing, grinding or a combination thereof The act of particle size reduction may naturally reduce the water concentration of the biomass due to the increased surface area of the particles and/or any local heating from the mechanical process.

In an aspect, the biomass in the biomass storage drum 120 may be a pretreated biomass. A pretreatment step may comprise drying, torrefaction, steam explosion, particle size reduction, densification and/or pelletization of the biomass. The biomass may be subjected to particle size reduction of the biomass, e.g., by maceration, crushing, grinding or a combination thereof. The pretreated biomass is stored in the biomass storage drum 120. A pretreated biomass may be taken in line 122 from the biomass storage drum 120.

In an exemplary embodiment, the biomass feed stream in line 122 may comprise biomass having a particle size of less than 5 mm. In another exemplary embodiment, the biomass feed stream in line 122 may comprise biomass having a particle size of less than 2 mm. In yet another exemplary embodiment, the biomass feed stream in line 122 may comprise biomass having a particle size of less than 1 mm. Preferably, the biomass in the biomass feed stream in line 122 is a fine powder having a particle size of less than or about 0.05 mm.

A catalyst stream may be passed to the mixer 140 in line 145.

An oil stream in line 159 is added to the mixer 140. In an aspect, a fresh oil stream in line 132, such as an oil stream which is not used before, may be taken from a fresh oil storage tank 130 and passed to the mixer 140. In an embodiment, the fresh oil stream in line 132 may be combined with the recycle oil stream in line 166 to provide the oil stream in line 159 which is passed to the mixer 140. The fresh oil stream in line 132 may be required for the start-up of the process to be gradually replaced by recycle oil as the reactor 150 generates sufficient bio-oil. Full replacement of the fresh oil stream in line 132 by the recycle oil steam in line 166 may be ultimately preferred.

The fresh oil stream in line 132 may comprise a mineral oil stream taken from a fossil source or it may be a biogenic oil stream. Biogenic includes materials typically obtained from plants or vegetable materials or furthermore also from animal sources. Preferably, the fresh oil stream in line 132 is entirely a biogenic material. Examples of biogenic material may include pyrolysis oil, hydrothermal liquefaction oil, and bio-diesel.

The oil stream in line 159 may be defined as a non-aqueous and/or a non-polar oil stream. In an embodiment, a mixed stream of the fresh oil stream and the recycle oil stream, preferably comprising a higher proportion of the recycle oil stream, may be passed to the mixer 140 in line 159. Perhaps the oil stream in line 159 may be pumped via a pump 133 and a pumped oil stream in line 134 is passed to the mixer 140. In an aspect, a control valve 135 may be provided on line 134 for maintaining a required flow rate of the oil stream to the mixer 140. In an embodiment, a sulfur source comprising a sulfiding agent in line 131 may be added to the fresh oil stream in line 132 and passed to the mixer 140. The control valves 125 and 135 can be used to control or adjust the proportions of the bio-oil and the petroleum stream fed to the mixer 140. In an aspect, the fresh oil stream in line 132 may be characterized as a stable oil stream having a desired concentration of the functional groups such as oxygenates. In the mixer 140, the biomass feed stream in line 122 is mixed with and the oil stream in line 159 to produce a slurry.

Referring back to the mixer 140, the biomass feed stream in line 124, and the oil stream in line 159 are mixed in the mixer 140 and kept well mixed at a ratio, as discussed herein later in detail, preferably with an excess of the biomass feed stream in line 124. The mixing of the components in the mixer 140 may produce a slurry. After mixing, a mixed stream comprising the biomass feed stream, and the oil stream may be taken in line 142 from the mixer 140. The mixed stream in line 142 comprises solid particles of the biomass. So, a particular type of pump may be needed to pump the mixed stream from the mixer 140 to the downstream reactor. In an aspect, the mixed stream in line 142 may be passed to a high-pressure sludge pump or a high-pressure solid phase pump 143. From the pump 143, a pumped mixed stream is taken in line 147 and passed to the reactor 150. In an embodiment, the pumped biomass feed stream in line 124 and the pumped oil stream in line 134 are mixed in the mixer 140 at a mass ratio of the biomass feed stream and the oil stream of about less than 1 at the start-up to provide a mixed stream. In an aspect, the mixed stream 142 comprises the biomass stream and the oil stream in a ratio of about 0:100 to about 80:20 by mass at start-up.

In an embodiment, the mixed stream in line 142 is passed to a liquid phase hydrotreating (LPH) reactor 150. A hydrogen stream in line 144 may also passed to the reactor 150. In an embodiment, the hydrogen stream in line 144 may be blended or mixed with the mixed stream in line 142 and passed to the reactor 150. A catalyst stream in line 145 may also be passed to the reactor 150. In an embodiment, the catalyst stream may be blended or mixed with the mixed stream in line 142 to provide a combined stream in line 146 which is passed to the reactor 150. In another embodiment, the catalyst stream in line 145 may be added into the mixer 140. In the reactor 150, the fresh oil stream, the biomass feed stream, the recycle oil stream, and the hydrogen stream may be reacted over a catalyst in a continuous liquid phase to provide an upgraded bio-oil. In an aspect, the biomass feed stream in the combined stream in line 146 may be charged to the reactor 150 at a predetermined volumetric rate to provide a liquid hourly space velocity between about 0.1 hr⁻¹ to about 1.0 hr⁻¹.

In an alternate embodiment, the biomass feed stream in line 122 may comprise predominantly solid biomass. In such an embodiment, the biomass feed stream in line 122 may not need to be mixed with the oil stream in line 159 in the mixer. In an exemplary embodiment, the biomass feed stream in line 122 comprising predominantly solid biomass may be fed into the reactor 150, perhaps directly. Further, the oil stream in line 159 may be fed to the reactor perhaps with the catalyst.

Liquid phase hydrotreating (LPH) is used for upgrading the heavy hydrocarbon feedstocks to produce distillate products. The hydrotreating catalyst typically comprises a solid particulate compound of a catalytically active metal, metal sulfide, metal oxide, or a metal in elemental form, either alone or supported on a refractory material such as an inorganic metal oxide, such as alumina, silica, titania, zirconia, and mixtures thereof. Other suitable refractory materials include carbon, coal, and clays. Zeolites and non-zeolitic molecular sieves are also useful as solid supports. One advantage of using a solid particulate either alone or supported is its ability to act as a “coke getter” or adsorbent of asphaltene precursors that have a tendency to foul process equipment upon precipitation. A preferred type of catalyst may include a metal sulfide. A preferred metal sulfide may comprise molybdenum sulfide. The catalyst in the catalyst stream in line 145 may be a colloidal catalyst. The catalyst is typically not a strong acid catalyst.

Catalytically active metals for use in the process 100 for LPH may include those from Group IVB, Group VB, Group VIB, Group VIIB, or Group VIII, which are incorporated in amounts effective for catalyzing desired hydrotreating reactions to provide, for example, lower boiling hydrocarbons that may be fractionated from the LPH effluent as naphtha and/or distillate products. Representative metals include iron, nickel, molybdenum, vanadium, tungsten, cobalt, ruthenium, and mixtures thereof. The catalytically active metal may be present as a solid particulate in elemental form or as an organic compound or an inorganic compound such as a sulfide, for example iron sulfide or other ionic compound. Metal or metal compound nanoaggregates may also be used to form the solid particulates.

In some embodiments, the metal compounds can be formed in situ, as solid particulates, from a catalyst precursor such as a metal sulfite for example iron sulfite monohydrate that decomposes or reacts in the LPH reaction zone environment, or in a pretreatment step, to form a desired, well-dispersed and catalytically active solid particulate such as iron sulfide. Catalyst precursors also include oil-soluble organometallic compounds containing the catalytically active metal of interest that thermally decompose to form the solid particulate for example iron sulfide having catalytic activity. Such compounds are generally highly dispersible in the heavy hydrocarbon feedstock and normally convert under pretreatment or LPH reaction conditions to the solid particulate that is contained in the slurry effluent. Catalyst precursors also include oil-soluble organometallic compounds, inorganic molybdenum compounds, or chelated metal compounds containing the catalytically active metal. Molybdenum chelates including molybdenum octoate, molybdenum dithiocarbamate, and molybdenum naphthenate and molybdenum compounds such as ammonium heptamolybdate and phosphomolybdic acid thermally decompose to form the solid particulate through reaction with sulfidation components in the feed or other sulfidation additives such as dimethyl disulfide, di-tert-butyl (poly)sulfide, dibenzyl disulfide, (di)allyl (di)sulfide, ammonium sulfite, dimethyl sulfite, dithiothreitol, elemental sulfur or thiourea to form for example molybdenum disulfide having catalytic activity. An exemplary in situ solid particulate preparation, involving pretreating, the heavy hydrocarbon feedstock and precursors of the ultimately desired metal compound, is described, for example, in U.S. Pat. No. 5,474,977.

In another aspect, a catalyst precursor with the sulfidation component or the sulfidation additive may be provided in a line 131 and added to the fresh oil stream in line 132. In another aspect, a catalyst or a catalyst precursor may be added to the feed stream in line 122 or the fresh oil stream in line 132.

Alternatively, such metal sulfides or other active metal compounds can be formed ex-situ or in a separate process step through typical methods for producing metal sulfides. One such method includes hydrothermal synthesis where a molybdenum compound and sulfidation component are added to water with an additional reducing agent such as citric acid, oxalic acid, or hydrochloric acid or gaseous hydrogen. In some cases, the sulfidation component may also act as a reducing agent such as thiourea, ammonium sulfite, dimethyl sulfite, or dithiothreitol. The hydrothermal synthesis solution may be loaded into an autoclave reactor and sealed. If gaseous hydrogen is the reducing agent, the autoclave reactor can be pressurized from about 1378 kPag (200 psig) to about 10342 kPag (1500 psig) with hydrogen gas or the hydrogen gas can flow and bubble through the autoclave reactor. The autoclave reactor is then heated to a synthesis temperature of about 200° C. to about 350° C. under the foregoing hydrogen or inert gas pressure and held at the synthesis temperature for about 0.5 to about 16 hours. The autoclave reactor is allowed to cool to room temperature before depressurization and unloading. The solid catalyst can be collected such as by centrifugation, filtration, or drying. An example of hydrothermal metal sulfide synthesis is described in J. Espano, Phase Control in the Synthesis of Iron Sulfides, 145 J. Am. Chem. Soc. 18948-18955 (2023).

Another such method of forming metal sulfides ex situ could be a sulfiding procedure in a fixed bed reactor. Such methods involve loading a fixed bed reactor with a powdered or pelletized molybdenum compound and flowing a sulfiding gas, such as hydrogen sulfide, or a sulfiding liquid, such as oil doped with a sulfiding agent over the catalyst bed. The fixed bed reactor is heated to a sulfiding temperature of about 200° C. to about 350° C., for example, under the flow of sulfiding gas and/or hydrogen gas. The reactor is either pressurized before or after heating to sulfiding temperature to a pressure of about 1378 kPag (200 psig) to about 13790 kPag (2000 psig). The reactor may be heated slowly at, for example, 1° C./min and held at any temperature setpoints along the way to reach the final sulfiding temperature. The reactor may be held at temperature setpoints for hours to days. Once the sulfiding is complete, the reactor is cooled to room temperature and the catalyst is unloaded from the reactor in its metal sulfide form. The sulfided catalyst may be further reduced in particle size via grinding, milling, or other methods, so that it is a fine powder and highly dispersible.

Yet another method of forming metal sulfides ex situ could be a sulfiding procedure relying on chemical vapor deposition techniques. Such a method involves molybdenum compounds such as molybdenum trioxide, molybdenum dioxide, molybdenum foil, or dipotassium tetrathiomolybdate and sulfur compounds such as elemental sulfur, alkali sulfates, alkaline carth sulfates, or other metal sulfates or similar metal sulfites. A substrate is also used such as SiO₂/Si wafers, graphenes/graphites, or powdered or pelletized substrates commonly used as catalyst supports such as SiO₂, Al₂O₃, or TiO₂. Using a typical tube furnace synthesis reactor, the reactants and supports are typically placed in the reactor tube in a specific order with the sulfur source first (furthest upstream) followed by the molybdenum source downstream followed by the substrate further downstream. All compounds mentioned above are placed in a thermal zone in the tube furnace, typically in ceramic or other thermally and chemically resistant holders, which may be controlled as independent zones or as one zone. The substrate may be placed outside a thermal zone, if desired. This positioning is such that a gas flow through the tube first contacts the sulfur source, followed by the molybdenum source, followed by the substrate. A gas flow could include inert gas, hydrogen, steam, and/or oxygen/air. In typical operation, a gas flow is started and the tube furnace reactor zones are heated to a temperature that is suitable to vaporize one or more of the compounds mentioned above at ambient pressure, typically equal to or less than 1000° C. The compounds vaporize and flow downstream where they react with each other and deposit on the substrate. The synthesis may run until complete consumption of all reactants or the substrate may be moved in and out of the apparatus so that the deposition time is limited to several minutes. After synthesis completion, the resulting metal sulfide is collected by removal of the substrate holder. The metal sulfide catalyst can be used as-is or, in the case of depositions of flat substrates like silicon wafers, the catalyst powder may be optionally scraped off for use without the silicon wafer. An example of chemical vapor deposition metal sulfide synthesis is described in W. Fu, “Toward Edge Engineering of Two-Dimensional Layered Transition-Metal Dichalcogenides by Chemical Vapor Deposition,” 17 (17) ACS Nano 16348-16368 (2023).

Other suitable precursors include metal oxides that may be converted to catalytically active or more catalytically active compounds such as metal sulfides. In a particular embodiment, a metal oxide containing mineral may be used as a precursor of a solid particulate comprising the catalytically active metal for example iron sulfide on an inorganic refractory metal oxide support for example alumina. Bauxite represents a particular precursor in which conversion of iron oxide crystals contained in this mineral provides an iron sulfide catalyst as a solid particulate, where the iron sulfide after conversion is supported on the alumina that is predominantly present in the bauxite precursor.

The active metals employed in the hydroprocessing catalysts of the present disclosure as hydrogenation components may include the base metals of Group VIII, for example iron, cobalt, and nickel. In addition to these metals, other promoters may also be employed in conjunction therewith, including the metals of Group VIB, e.g., molybdenum and tungsten. The amount of hydrogenating metal in the catalyst can vary within wide ranges. Any amount between about 0.05 wt % and about 80 wt % may be used.

In an aspect, molybdenum may be provided as a ground hydrotreating catalyst of particle size typically less than 60 mesh, preferably less than 100 mesh, more preferably less than 200 mesh, and even more preferably less than 400 mesh. The hydrotreating catalyst may be sulfided in situ or ex situ using any method mentioned throughout. In an aspect, molybdenum may be provided as an organic molybdenum such as molybdenum octoate or molybdenum dithiocarbamate which because it is oil or hydrocarbon soluble may be added directly to the hydrocarbon feed separately from or with the carbon particles. The molybdenum may react with sulfur provided in the hydrocarbon feed or an additive to produce molybdenum sulfide in the reactor which is the active form of the molybdenum catalyst.

Nickel may be provided as a catalyst in the way molybdenum is added.

In another aspect, the catalyst is a nickel and molybdenum sulfide catalyst where nickel is incorporated into the molybdenum sulfide molecular structure to enhance catalytic activity but may also form separate nickel sulfide phases with their own separate catalytic activity. In syntheses mentioned throughout that involve an aqueous solution, nickel can be added by simply introducing a nickel compound to the aqueous solution before heating to final synthesis temperature. In syntheses that involve a solid and a gas or a solid and a liquid method, nickel compounds may be physically mixed with the molybdenum compounds. For in situ formation of the nickel and molybdenum sulfide in the LPH, an oil-soluble nickel compound may be added directly to the feed or added from a separate line into the LPH. Nickel compounds that could be used include nickel octoate, nickel nitrate hexahydrate, nickel sulfate, nickel sulfite, nickel acetate tetrahydrate, nickel citrate hydrate, nickel hydroxide, or nickel hydroxide carbonate. The molar ratio of molybdenum to nickel can range from about 1:1 to about 5:1, preferably about 2:1 to about 4:1, or preferably about 2.5:1 to about 3.5:1.

The sulfur can be provided by a solid or liquid sulfiding agent that is added via line 131 into the fresh oil stream in line 132 or added into a recycle stream to the reactor or premixed into the feed. Gaseous sulfiding agents like hydrogen sulfide can be added to the hydrogen line 144. Some preferred sulfiding agents are hydrogen sulfide, dimethyl disulfide, di-tert-butyl (poly)sulfide, dibenzyl disulfide, (di)allyl (di)sulfide, ammonium sulfite, dimethyl sulfite, dithiothreitol, elemental sulfur or thiourea.

An aqueous molybdenum may be derived from reacting MoO₃ with an aqueous acid or basic solution such as phosphoric acid or ammonium hydroxide, respectively. Molybdenum in aqueous or oil-soluble liquid form in a volume selected to achieve target concentration may be dropped onto carbon particles which may serve as a carrier.

Without help from other catalysts, the concentration of the molybdenum in the liquid feeds to the LPH reactor may be more than 0 wppm and no more than about 2 wt % in the liquid feed, suitably no more than about 0.5 wt % in the liquid feed, and typically no more than about 2000 wppm in the liquid feed. In some cases, the concentration of molybdenum may be no less than 1000 wppm in the liquid feed, and preferably not less than 500 wppm of the feed.

In preferred embodiments where the catalyst contains both nickel and molybdenum, the concentration of the molybdenum in the liquid feed to the LPH reactor is the same as specified above. The concentration of the nickel in the liquid feed to the LPH reactor may be more than 0 wppm and no more than about 2 wt % in the liquid feed, suitably no more than about 0.5 wt % in the liquid feed, and typically no more than about 2000 wppm in the liquid feed. In some cases, the concentration of nickel may be no less than 1000 wppm in the liquid feed, and preferably not less than 500 wppm of the feed. By feed, all feed streams to the reactor are meant.

In some embodiments, a stream containing catalyst may be recycled to the reactor 150. Thus the concentration of molybdenum in the reactor can be controlled at a steady state greater than the concentration of molybdenum in the liquid feed. The concentration of molybdenum in the reactor liquid is typically between 0.1 wt % and 10 wt %, preferably between 0.5 wt % and 7 wt % and more preferably between 2 wt % and 7 wt %, and even more preferably between 0.2 wt % and 3 wt %.

In an embodiment, the catalyst in the catalyst stream 145 may comprise a supported hydrotreating catalyst. In another embodiment, the catalyst in the catalyst stream 145 may comprise an unsupported hydrotreating catalyst. The hydrotreating catalysts may be a nickel or nickel/molybdenum dispersed on a high surface area support. Such base metal catalysts may be sulfided. In yet another embodiment, the catalyst in the catalyst stream 145 may comprise an unsupported solid (heterogeneous) hydrotreating catalyst. Hydrotreating catalysts may be any combination of molybdenum, nickel, tungsten, and/or cobalt. Such base metal catalysts may be sulfided. In another embodiment, the catalyst in the catalyst stream 145 may comprise an unsupported (homogeneous) liquid hydrotreating catalyst. The hydrotreating catalysts may be any combination of molybdenum, nickel, tungsten, and/or cobalt suspended in a suitable liquid such as any oil. Such base metal catalysts may be sulfided.

In an aspect of the present disclosure, the catalyst in the catalyst stream 145 may comprise a hydrotreating catalyst with or without promoters for deoxygenation and/or hydrodcoxygenation of the biomass feed.

In an exemplary embodiment, the catalyst in the catalyst stream 145 may comprise molybdenum sulfides with or without promoters for deoxygenation and/or hydrodeoxygenation of the biomass feed in the reactor 150.

In an embodiment, a control valve 149 may be provided on the hydrogen line 144 to regulate the flow of the hydrogen to the reactor 150. The hydrogen added into the reactor 150 in line 144 is an external hydrogen which means the hydrogen that does not originate from the biomass. The liquefaction and deoxygenation of the biomass inside the reactor 150 may include various chemical reactions. One of the reactions may be a reforming reaction. In an aspect, the reforming reactions inside the reactor 150 may provide a minor amount of internal hydrogen originating from the biomass. On the other hand, the hydrogen in line 144 is added to the reactor 150 from another source, which may be any suitable source of gaseous hydrogen.

In an embodiment, the hydrogen stream may be blended or mixed with the mixed stream in line 147 and passed to the reactor 150. In the reactor 150, the mixed stream, and the hydrogen stream may be reacted over the catalyst in a continuous oil phase to provide a reactor effluent stream in line 154. In accordance with an embodiment of the present disclosure, the reactor 150 may be a slurry reactor. The slurry reactor may have some advantage over an ebullating bed such as a slurry reactor enables a continuous addition of fresh catalyst into the reactor. The continuous addition of fresh catalyst may help overcome significant catalyst deactivation. Other advantages of a slurry reactor include: 1) consistently high deoxygenation versus time, 2) continuous operation at less severe conditions, and 3) preventing the increase in viscosity of the heavy oil product over time due to catalyst deactivation and decreasing deoxygenation, which may lead to reactor failure via bio-oil polymerization. In another embodiment, the reactor 150 may be a bubbling bed reactor.

A distinguishing feature of reactor 150 is that a catalyst stream may enter and leave the reactor with the liquid products and flow downstream to separation units, as opposed to fluidized bed-style reactors where the catalyst remains in the reactor and does not require downstream separation. Fresh catalyst may be continuously fed to reactor 150 to make up for catalyst lost via product streams. The continuous addition of fresh catalyst may help prevent significant catalyst deactivation as would be seen in fluidized bed-style reactors. The advantages of fresh catalyst addition may include: 1) consistently high deoxygenation versus time, 2) continuous operation at less severe conditions, and/or 3) preventing the increase in viscosity of the heavy/recycle oil product over time due to catalyst deactivation and decreasing deoxygenation, which eventually leads to reactor failure via bio-oil polymerization.

In an embodiment, the biomass feed stream in line 124 may be passed to the reactor 150 at a volumetric rate to achieve a space velocity between 0.1 to 1.0 hr⁻¹.

The biomass feed stream may comprise about 1 to about 7500 wppm sulfur, typically no more than about 5000 wppm sulfur. In an embodiment, the sulfiding agent in line 131 may be fed to the reactor 150. The sulfiding agent may activate the catalyst. Alternatively, the sulfiding agent in line 131 may be added into the mixed stream in line 147 and passed to the reactor 150. Moreover, the sulfiding agent in line 131 may be added to the oil stream in line 159 and passed to the mixer 140. The active metal on the catalyst may react with the sulfur provided in the feed and/or the sulfiding agent to produce metal sulfide in the reactor 150 which is the active form of the metal catalyst.

The concentration of the active metal in a supported heterogeneous catalyst may be no more than about 20 wt %, or no more than about 18 wt %, suitably no more than about 14 wt % and typically no more than about 8 wt % but at least 0.5 wt %. The concentration of the active metal in an unsupported heterogeneous catalyst may be no more than about 80 wt %, or no more than about 70 wt %, suitably no more than about 60 wt % and typically no more than about 50 wt % but at least about 5 wt %. The concentration of the active metal in an unsupported homogeneous liquid catalyst may be no more than about 60 wt %, or no more than about 40 wt %, suitably no more than about 20 wt %, but no less than about 0.5 wt %, and typically no less than about 5 wt %. In some embodiments, the concentration of the active metal in the reactor may be no more than 20 wt %, suitably no more than 15 wt % and preferably no more than 10 wt % but may be not less than about 600 wppm, typically no less than 2000 wppm, suitably no less than about 2 wt %, preferably no less than 4 wt %. The concentration of the active metal in the feed may be no more than 10 wt %, suitably no more than 8 wt % and preferably no more than 5 wt % but may be not less than about 300 wppm, typically no less than 1000 wppm, typically, no less than about 1 wt %, suitably no less than 2 wt % due to the high activity of the catalyst at elevated temperature. In an exemplary embodiment, the active metal may be molybdenum.

Conditions in the reactor 150 generally include a temperature from about 315° C. (600° F.) to about 538° C. (1000° F.), or about 321° C. (610° F.) to about 482° C. (900° F.), or about 340° C. (644° F.) to about 470° C. (878° F.) or about 350° C. (662° F.) to about 450° C. (842° F.), a pressure from about 3.5 MPag (500 psig) to about 30 MPag (4351 psig), suitably 5.5 MPa (800 psig) to about 19.3 MPa (2800 psig), preferably 6.8 MPa (1000 psig) to about 13.8 MPa (2000 psig), or more preferably no more than about 10.3 MPa (1500 psig).

In another exemplary embodiment of the present disclosure, the reactor 150 may be a continuous stirred tank reactor (CSTR). Operating conditions in the CSTR 150 may be as given above but may preferably include a temperature from about 300° C. (572° F.) to about 500° C. (932° F.) or from about 400° C. (752° F.) to about 450° C. (842° F.) or about 350° C. (662° F.) to about 450° C. (842° F.), a pressure from about 6890 kPag (1000 psig) to about 17240 kPag (2500 psig), or from about 10342 kPag (1500 psig) to about 17790 kPag (2000 psig) and a residence time of about 30 mins to about 8 hours.

In accordance with the present disclosure, the reaction conditions in the reactor 150 comprise higher concentration of oil than water. So, the liquefaction reaction of the biomass takes place in a continuous majority oil phase. No free water is added to the reactor 150 for liquefying the biomass. Water that may be present in the reactor 150 is present within the biomass feed, but no free water is added to the reactor independently of the feed. The water that may be present in the reaction within the reactor 150 of the current process is not “independently added”. Any presence of water in the reactor 150 originates from the biomass feed itself. So, free water is not added to the reactor 150 from any source on purpose. A separate aqueous phase or water is also not recycled to the reactor 150 on purpose. However, a very small concentration of water may be entrained in a recycle oil fraction as described later in detail.

In an embodiment, the amount of water that may be present in the reactor 150 is less than about 5% by weight. In an embodiment, the amount of water that may be present in the reactor 150 is less than about 30 wt % or less than about 25 wt % or less than about 20 wt % or less than about 15 wt % or less than about 10 wt % or less than about 5 wt %. In an exemplary embodiment, the combined stream in line 146 may comprise less than about 5 wt % free water.

In the reactor 150, liquefaction of the biomass is performed under the aforesaid reaction conditions in the presence of a predominant concentration of oil in the reactor 150. In liquefaction, the solid biomass is converted into one or more liquefied products. Liquefaction of biomass can comprise cleavage of covalent linkages in the biomass. For example, liquefaction of a lignocellulosic material can comprise cleavage of covalent linkages in the cellulose, hemicellulose and lignin molecules and/or cleavage of covalent linkages between lignin, hemicelluloses and/or cellulose molecules.

The liquefaction of the biomass in the reactor 150 can be defined as a single process step liquefaction. No pre-pyrolysis of the biomass feed is required prior to charging the reactor 150. The liquefaction of the biomass feed in the reactor 150 includes both the liquefaction and the hydrotreatment including the deoxygenation of the biomass feed in one single step inside the reactor 150. The liquefaction of the biomass feed in the reactor 150 is performed in the presence of hydrogen inside the reactor. The hydrogen environment provides the advantage of performing simultaneous hydrodeoxygenation reactions, in addition to non-hydrogen-based deoxygenation reactions. The single process step biomass liquefaction process of the present disclosure does not involve extremely high pressures which typically takes place in the hydrothermal liquefaction technology and does not make use of subcritical or supercritical water as the main solvent and reactant to liquefy the biomass. The catalyst helps decompose and deoxygenate the biomass into an upgraded and stable bio-oil that is ready for further refining or for use as-is. These advantages make the liquefaction of the biomass in the reactor 150 less complex and easier to handle than the hydrothermal liquefaction technology and provide an upgraded and stable bio-oil in a single process step. The single process step for liquefaction and hydrotreatment of the biomass may not need a subsequent step of hydrodeoxygenation or cracking. The single process step of the present disclosure comprises an integrated deoxygenation and/or hydrodeoxygenation step for liquefying the biomass in the reactor 150.

In the liquefaction reaction, the catalyst and the biomass disperse in the oil and the biomass liquefaction is catalyzed in the continuous oil phase inside the reactor. The elevated reaction temperature renders the catalyst active in the oil phase. Particularly, the elevated reaction temperature renders the catalyst more active than conventional catalyst which enables a lower oil to biomass weight ratio.

A reactor effluent stream comprising an upgraded bio-oil stream may be taken in line 154 from the reactor 150. The reactor effluent stream in line 154 is passed to a hot separator 160. In the hot separator 160, heavy oil is separated from the light oil. A hot bottoms stream is taken in line 156 from the bottoms of the hot separator 160. In an exemplary embodiment, the hot bottoms stream in line 156 is a stable oil stream. The hot bottoms stream which contains catalyst is separated and taken in line 156 from the hot separator 160. The hot bottoms stream in line 156 comprises a majority of the catalyst, for example all the catalyst exiting from the reactor 150 may be taken in the hot bottoms stream in line 156. In an aspect, the hot bottoms stream in line 156 may be characterized as a heavy oil stream comprising catalyst. Light oil is taken in a hot overhead stream in line 155 from the hot separator 160. Water is also separated in the hot separator 160 which is taken with the light oil in the hot overhead stream in line 155. The hot separator 160 may be run at a temperature of about 250° C. to about 400° C. and at a pressure of about the pressure of the reactor 150.

In an aspect, the stable oil stream in line 156 may be characterized by an acid number of no more than 60 mg KOH/g, preferably no more than 50 mg KOH/g, and more preferably no more than 40 mg KOH/g.

The hot bottoms stream in line 156 is passed to a recycle tank 177. A heavy oil stream in line 179 may be taken from a side of the recycle tank 177. In an aspect, the heavy oil stream in line 179 may be filtered, centrifuged, vacuum flashed, or wiped film evaporated to remove a heavy product stream lean of catalyst. In an embodiment, the heavy oil stream in line 179 is passed to a catalyst separation vessel 136 for separating catalyst that may be present. In exemplary embodiment, the catalyst separation vessel 136 may be selected from a filtration vessel, a centrifuge, a vacuum distillation column, a wiped film evaporator, or a combination thereof. In the catalyst separation vessel 136, the catalyst is separated from the heavy oil. A heavy oil product stream is taken in line 137 from the catalyst separation vessel 136. A concentrated catalyst stream comprising catalyst in heavy oil is taken in line 138 from the vessel 136. In an aspect, the concentrated catalyst stream in line 138 may be recycled to the reactor 150.

A wiped film evaporator (WFE) uses a hinged blade with minimal clearance from the internal surface to agitate the flowing catalyst containing stream to effect separation of catalyst from heavy oil. In the catalyst separation vessel 136 comprising a WFE, the heavy oil stream in line 179 enters tangentially above a heated internal tube and is distributed evenly over an inner circumference of the tube by the rotating blade perhaps at vacuum. Catalyst particles spiral down the wall while bow waves developed by rotor blades generate highly turbulent flow and optimum heat flux. The heavy oil evaporates rapidly and vapors can flow either co-currently or counter-currently against the catalyst particles. In a simple WFE design, heavy oil may be condensed in a condenser located outside but as close to the evaporator as possible.

Other evaporative techniques may be used to separate the catalyst from the heavy oil in the catalyst separation vessel 136.

In an aspect, a recycle oil stream in line 166 may be taken from the heavy oil stream in line 137. The recycle oil stream in line 166 may be recycled to the reactor. In an embodiment, the remaining heavy oil stream in line 184 may be processed in an FCC unit or a hydroprocessing unit or a reforming unit 180 to provide a product stream in line 182. The recycle oil stream in line 166 may have a boiling point curve typical of marine fuels known in the art. For instance, the recycle oil stream in line 166 may have a T5 of about 150° C. to about 200° C. and/or a T90 of about 425° C. to about 600° C.

The recycle oil stream in line 166 may be mixed with the biomass feed stream in line 124 in the mixer 140. Alternatively, the recycle oil stream in line 166 may be recycled to the reactor 150. The recycle oil stream in line 166 may comprise the catalyst fines which are recycled back to the reactor 150. In accordance with the present disclosure, the recycle oil stream in line 166 is a non-aqueous and/or a non-polar stream which may serve as a thermal agent to facilitate the liquefaction of the biomass in the reactor 150. The recycle oil stream in line 166 may comprise entrained water. In an embodiment, the recycle oil stream in line 166 may comprise about less than 5 wt % water, or about less than 3 wt % water, preferably less than 2 wt % water, suitably less than 1 wt % water, more preferably less than 0.5 wt % water, and most preferably less than 0.1 wt % water.

The recycle oil stream in line 166 may be recycled to the reactor 150 at a recycle oil to biomass feed mass ratio of less than about 2:1, or less than about 1.9:1, or less than about 1.7:1. In an embodiment, the recycle oil stream in line 166 may be recycled at a recycle oil to biomass feed mass ratio of no more than about 1.5:1. In an embodiment, the recycle oil stream in line 166 may be recycled at a recycle oil to biomass feed mass ratio of at least about 0.4:1. In an exemplary embodiment, the recycle oil stream in line 166 may be recycled to the reactor 150 at a recycle oil to biomass feed weight ratio of no more than about 0.4:1 to about 1.9:1. Such a recycle ratio provides a continuous oil phase, perhaps a predominant oil phase, in the reactor 150. The recycle ratio enables maintenance of a continuous oil phase which facilitates catalytic deoxygenation and liquefaction of the biomass in the reactor 150 in the oil phase itself.

In another embodiment, the recycle oil stream in line 166 is recycled to the mixer to provide the mixed stream in line 142 predominantly comprising the biomass feed stream. The recycle oil stream in line 166 may be pumped with a pump 157 to provide a pumped recycle oil stream which is passed to the mixer 140 in line 159.

In an aspect, the flow rate of the biomass feed stream to the mixer 140 is greater than the flow rate of the oil stream. In an embodiment, the amount of the oil stream that may be present in the mixed stream in line 142 may range from about 10 wt % to about 60 wt % of the mixed stream.

In an aspect, the space velocity of the reactor 150 may be selected to approximate the recycle oil to biomass feed mass ratio desired. In an embodiment, the biomass feed stream in line 124 may be fed to the reactor 150 at a volumetric rate to achieve a space velocity between 0.1 to 1.0 hr⁻¹, preferably 0.2 to 0.9 hr⁻¹, or more preferably 0.3 to 0.8 hr⁻¹, irrespective of the recycle oil rate, where space velocity is defined as the volumetric flow rate of the biomass divided by the volume of the reactor. In this embodiment, the biomass source, particle size, and particle shape will determine the loose bulk density, measured by ASTM D7481, which is the preferred density measurement to use for biomass volumetric flow rate calculations.

The hot overhead stream comprising the light oil in line 155 may be cooled and charged to a cold separator 165. In the cold separator 165, gaseous components may be separated from the light oil. The gaseous components are separated and taken in line 164 from the cold separator 165. The cold overhead stream in line 164 may be purified to obtain a hydrogen stream which may be recycled to the reactor 150. A bottoms light oil stream comprising the upgraded bio-oil stream and aqueous components is taken in line 169 from the cold separator 165. The bottoms light oil stream in line 169 comprises water that should be separated from the upgraded bio-oil stream. The cold separator 165 may be operated at a temperature of about 0 to about 75° C. and at a pressure of about the pressure of the reactor 150.

In an embodiment, the bottoms light oil stream in line 169 is passed to an aqueous separator 147 for separating water from the upgraded bio-oil. Water is separated and taken in an aqueous bottoms line 148 from the aqueous separator 147. A light upgraded bio-oil stream is taken in line 139 from the aqueous separator 147 lean in water concentration. The aqueous separator 147 may be operated at a temperature of about 0 to about 75° C. and at a pressure of about 0 MPa (gauge) (0 psig) to about 1 Mpa (gauge) (150 psig).

In accordance with the present disclosure, the process 100 may comprise an analyzer 161 for analyzing the composition of various streams going in and out from the reactor 150. The analyzer 161 may be adapted to take corrective actions for adjusting the composition of one or more streams.

For a once-through reactor 150, the analyzer 161 may measure the composition of the material inside the once-through reactor 150. If the composition of the material does not fall within a predetermined range, adjustments can be made to the reactor conditions, feed conditions such as proportions of the bio-oil stream in line 122 and the stable oil stream comprising the petroleum stream in line 134 blended together.

In an embodiment, the light upgraded bio-oil stream may be taken in line 168 from line 139 through an open control valve 167 which may be in communication with the analyzer 161.

In an exemplary embodiment, the light upgraded bio-oil stream may be taken in line 168 through the open control valve 167 and passed to a FCC unit 180 to provide a FCC product stream in line 182. In another exemplary embodiment, the light upgraded bio-oil stream may be taken in line 168 through the open control valve 167 and passed to a hydroprocessing unit 180 to provide a hydroprocessing unit product stream in line 182. In yet another exemplary embodiment, the light upgraded bio-oil stream may be taken in line 168 through the open control valve 167 and passed to a reforming unit 180 to produce a reformed product stream in line 182.

In a preferred embodiment, the light upgraded bio-oil stream in line 168 may be first fractionated in a fractionation column 170 to separate the light upgraded bio-oil stream in line 168 into one or more hydrocarbon streams. The light upgraded bio-oil stream in line 168 may be passed to the fractionation column 170 to provide an overhead stream in line 171. The overhead stream in line 171 may be passed to a receiver 173 to further separate the overhead stream. From the receiver 173, LPG and light gases are separated in net overhead stream in line 172. The liquid stream in line 174 from the receiver 173 is separated into a reflux stream in line 175 and a naphtha stream in line 176. A kerosene stream may be taken in line 181 from a side of the fractionation column 170. The reflux stream in line 175 is recycled back to the fractionation column 170. From the bottoms of the fractionation column 170, a diesel stream may be taken in line 178. A reboiling stream may be taken from the diesel stream in line 178, heated in the reboiler 183 and a reboiled stream in line 185 may be passed to the fractionation column 170.

The fractionation column 170 may be operated at vacuum pressure. In an embodiment, fractionation column 170 may be operated at an overhead pressure of about 34 kPa (gauge) (5 psig) to about 173 kPa (gauge) (25 psig), and a bottoms temperature of about 500° C. (932° F.) to about 750° C. (1382° F.) or about 500° C. (932° F.) to about 600° C. (1112° F.).

A portion or an entirety of the naphtha stream in line 176 may be passed to the reforming unit 180 or another downstream processing unit.

In an embodiment, a portion or an entirety of the diesel stream in line 178 may be passed to the FCC unit 180 or the hydroprocessing unit 180 or the reforming unit 180.

In another embodiment, a portion or an entirety of the kerosene stream in line 181 may be passed to the FCC unit 180 or the hydroprocessing unit 180 or the reforming unit 180.

In an exemplary embodiment, the heavy oil stream in line 184 is passed to the FCC unit 180 or the hydroprocessing unit 180 or the reforming unit 180 to provide the product stream in line 182.

The product bio-oil stream in line 182 comprises a much smaller concentration of oxygenates than the biomass feed stream in line 122. In an embodiment, the product bio-oil stream in line 182 comprises no more than about 20 wt % oxygenates, preferably, no more than about 15 wt % oxygenates, more preferably no more than about 10 wt % oxygenates, and most preferably no more than 5 wt % oxygenates. The product bio-oil stream taken in line 182 may be processed to produce one or more fuel streams. In an aspect, the product bio-oil stream in line 182 may be passed to a FCC unit or a hydroprocessing unit 180 to provide one or more fuel streams in line 186.

When a recycle oil is employed, the composition of the material inside the reactor 150 may also be analyzed. If the composition of the material does not fall within a predetermined range, adjustments can be made to the reactor conditions, feed conditions such as proportions of the biomass stream in line 122 and the stable oil stream comprising the petroleum stream in line 134 and/or the recycle oil stream in line 166 fed to the reactor 150.

For example, the analyzer 161 may measure the composition of the reaction mixture inside the reactor 150 using, for example, one or more of infrared (IR) spectroscopy and nuclear magnetic resonance (NMR) spectroscopy.

Attenuated Total Reflectance (ATR) is an infrared (IR) spectroscopy which may also be used in accordance with the present disclosure. ATR-IR is a sampling technique in which the sample is placed in intimate contact with a crystal having a high index of refraction. The IR light is brought in from the bottom and reflected from the surface of the crystal. Samples were placed as-is onto the diamond crystal for ATR IR spectrum collection (64 scans, 2 cm-1 resolution). The IR spectra may be collected on a Nicolet is 50 FTIR spectrometer (or an equivalent research grade spectrometer), truncated and baseline corrected in GRAMS AI software, and deconvolved and plotted in OriginPro 2016.

For integration and deconvolution of the spectra, two approaches may be taken. Simple integration of spectral regions may be performed for different functional groups. The integration areas for various functional groups are measured. In accordance with the present disclosure, the following are roughly the integration areas for each functional group: about 3100-3695 cm-1 for hydroxyl groups, about 2800-2995 cm-1 for hydrocarbon groups, and about 1000-1315 cm-1 regions for methoxy groups. For the C═O and C═C regions, the spectra may be deconvolved by first baseline correcting the region, then fitting multiple peaks using the Origin Pro software. Spectra may not be normalized before deconvolution since there is no internal standard, thus, only area ratios may be used for sample comparison. The aromatic C═C band arca is typically from the deconvolved bands in the region ranging from about 1500 cm-1 to about 1600 cm-1, the alkene C═C band area in the region ranging from about 1600 cm-1 to about 1700 cm-1, and the C═O band area in the region ranging from about 1700 cm-1 to about 1800 cm-1. Depending on the complexity of the region, some spectra could be deconvoluted into 6 bands or as many as 9 bands.

Total carbon “C” value may also be calculated. The total carbon “C” value is equal to the sum of the integrated regions of CHx stretching and C═C stretching so that C equals (CHx+C═C) integrated band areas. Similarly, the total oxygen “O” value is equal to the sum of the integrated regions of C═O and C—O stretching so that O equals (C═O+C—O) integrated band areas. All other band areas identify the specific molecular vibrations that they represent.

Based on the band area values of these functional groups, a band area ratio value is also calculated for various functional groups. Band area ratio is a unitless parameter which remains the same for all measuring instruments.

In addition to infrared spectroscopy, nuclear magnetic resonance spectroscopy and titration, oxygenates content in oils can further be measured by gas chromatography methods such as ASTM UOP960, GCxGC, or other chromatographic methods. Combustion analysis such as ASTM UOP649 can be used to measure total oxygenate content in an oil. Other methods known in the art may also be used.

The NMR spectroscopy determines the physical and chemical properties of atoms or molecules. Proton (1H) NMR is one of the most widely used NMR methods. Different nuclei can also be detected by NMR spectroscopy, 1H (proton), 13C (carbon 13), 15N (nitrogen 15), 19F (fluorine 19), among many more. 1H and 13C are the most widely used. Phenolics may also be measured using NMR spectroscopy. Characterization of the light upgraded bio-oil stream with the help of the analyzer 161 may be used to determine the concentration of specific molecular functional groups including aldehydes, ketones, esters, ethers, phenolics, sugars, and carboxylic acids. Typically, the values of 1H and 13C are measured in mole % of the respective H or C atoms as per NMR spectroscopy. The procedure for measuring the 1H and 13C NMR spectral regions was as below:

### ¹H Liquid State Procedure

NMR spectra of the samples may be collected by employing a Bruker Avance Spectrometer operating at a frequency of 500.1317 for 1H experiments. The samples may be prepared by dissolving 2-3 drops of bio-oil in 0.6 mL of chloroform-d with a trace quantity of tetramethylsilane being added as an internal reference. Quantitative results may be obtained using a 90° pulse with 10 ms length and 10 seconds of delay between acquisitions. The number of scans may be 128. Processing includes baseline correction and the use of 1 Hz exponential line broadening before Fourier transformation. The spectra may be further integrated by regions corresponding to the following lumped functional groups: 0.5-1.5 ppm alkanes, 1.5-3 ppm aliphatics alpha to heteroatom or unsaturation, 3-4.4 ppm alcohols, methylene-dibenzene, 4.4-6 ppm olefins, methoxys, carbohydrates, 6-7.18 ppm (hetero) aromatics, furans, 7.18-8.5 ppm (hetero) aromatics, 8.5-10.1 ppm aldehydes.

### ¹³C Liquid State Procedure

NMR spectra of the samples were collected by employing a Bruker Avance Spectrometer operating at a frequency of 125.7715 for 13C experiments. The samples may be prepared using a 50:50 (v/v) mixture of chloroform-d and bio-oil analyte. Additionally, a trace quantity of tetramethylsilane was added as an internal reference and chromium acetylacetonate was used as a relaxation agent. Quantitative results were obtained using an inverse-gated pulse sequence, and all 13C spectra were acquired by using 11.3 us pulses and 10 seconds of delay between acquisitions. The number of scans was 2048. Processing included baseline correction and the use of 3 Hz exponential line broadening before Fourier transformation. The spectra were further integrated by regions corresponding to the following lumped functional groups: 0-27 ppm short aliphatics, 27-54 ppm long and branch aliphatics, 54-94 ppm alcohols, ethers, phenyl methoxy groups, carbohydrates, 94-167 ppm aromatics, olefins, heteroaromatics, furans, 167-186 ppm esters, carboxylic acids, 186-225 ppm ketones, aldehydes.

As per 1H NMR spectroscopy the reaction mixture inside the reactor 150 and/or heavy oil stream in line 179 should comprise an aldehyde at a concentration of about 0 mol % H to about 3 mol % H or preferably about 0 mol % H to about 2 mol % H, or more preferably about 0 mol % H to about 1 mol % H. As per 13C NMR spectroscopy the reaction mixture inside the reactor 150 should comprise at least one of the group ketones and aldehydes at a concentration of about 0 mol % C to about 6 mol % C, or preferably about 0 mol % C to about 4 mol % C, or more preferably about 0 mol % C to about 2 mol % C; at least one of the group carboxylic acids and esters at a concentration of about 0 mol % C to about 6 mol % C or preferably about 0 mol % C to about 4 mol % C or more preferably about 0 mol % C to about 3 mol % C; and at least one of the group ethers, alcohols, phenyl methoxy groups, and carbohydrates at a concentration of about 0 mol % C to about 11 mol % C, or preferably about 0 mol % C to about 9 mol % C, or more preferably about 0 mol % C to about 7 mol % C.

The composition of the material inside the reactor 150 such as the reaction mixture and/or heavy oil stream 179 may also be characterized by a band arca ratio of oxygenates measured by ATR-IR spectroscopy. In an exemplary embodiment, the composition of the reaction mixture inside the reactor 150 should comprise a ratio of oxygenates of one or more of a (C—O)/C ratio from about 0 to about 0.7 or preferably from about 0 to about 0.5, or more preferably from about 0 to about 0.4; a (C═O)/C ratio from about 0 to about 0.6 or preferably from about 0 to about 0.5 or more preferably from about 0 to about 0.4; an OH/C ratio from about 0 to 3, or preferably from about 0 to about 2.5, or more preferably from about 0 to about 2; and an O/C ratio from about 0 to 1.7; or preferably from about 0 to about 1 or more preferably from about 0 to about 0.6.

Applicants have discovered that producing an upgraded bio-oil stream that is missing or has reduced levels of specific functional groups eliminates the challenge of bio-oil polymerization in a reactor such as a CSTR or a slurry reactor. Since the liquid contents of the reactor are depleted in specific functional groups, reactions that lead to bio-oil polymerization are suppressed. Applicants have analyzed the liquid effluent comprising the upgraded bio-oil from the reactor to identify the specific functional groups causing the bio-oil polymerization. In a well-mixed CSTR reactor, the liquid effluent of the reactor is representative of the liquid composition at all locations in the reactor. Applicants disclose various methods or tests to analyze the liquid effluent from the reactor including spectroscopy such as nuclear magnetic resonance (NMR) spectroscopy and attenuated total reflection-infrared (ATR-IR) spectroscopy. Other tests may include an acid number test and carbon-hydrogen-nitrogen-oxygen (CHNO) elemental analysis for example ASTM D5291 CHN, and ASTM UOP649 Oxygen. Acid number test may include TAN (total acid number) and CAN (carboxylic acid number). Using one or more of these tests, applicants identify the “bad actors” that cause bio-oil polymerization. Also, by identifying these groups, applicants distinguish an acceptable reactor effluent stream which can be used as-is or passed to further processing from an unacceptable reactor effluent stream which is insufficiently stable for downstream processing.

In an embodiment, the light upgraded bio-oil stream in line 168 may be analyzed at desired time intervals and analyzed offline using one or more of the infrared (IR) spectroscopy and NMR spectroscopy by the analyzer 161 to determine the composition and quality of the light upgraded bio-oil stream. In accordance with an exemplary embodiment, as per 1H NMR spectroscopy an acceptable concentration in the light upgraded bio-oil stream in line 168 may comprise aldehydes at a concentration of about 0 mol % to about 4 mol % H, or preferably about 0 mol % to about 2 mol % H, or more preferably about 0 mol % to about 1 mol % H. In accordance with another exemplary embodiment, as per 13C NMR spectroscopy the light upgraded bio-oil stream in line 168 may comprise at least one or more of at least one of the group ketones and aldehydes at a concentration of about 0 mol % C to about 6 mol % C, or preferably about 0 mol % C to about 5 mol % C, or more preferably about 0 mol % C to about 3.5 mol % C; at least one of the group carboxylic acids and esters at a concentration of about 0 mol % C to about 6 mol % C, or preferably about 0 mol % C to about 5 mol % C, or more preferably about 0 mol % C to about 4 mol % C; and at least one of the group ethers, alcohols, phenyl methoxy groups, and carbohydrates at a concentration of about 0 mol % C to about 11 mol % C, or preferably about 0 mol % C to about 9 mol % C, or more preferably about 0 mol % C to about 7 mol % C, or yet more preferably about 0 mol % C to about 5 mol % C.

In accordance with the present disclosure, the light upgraded bio-oil stream in line 168 may be characterized by a band area ratio of oxygenates measured by ATR-IR spectroscopy. In an exemplary embodiment, the light upgraded bio-oil stream in line 139 may comprise a ratio of oxygenates of one or more of a (C—O)/C ratio from about 0 to about 0.7, or preferably from about 0 to about 0.5, or more preferably from about 0 to about 0.4; a (C═O)/C ratio from about 0 to about 0.6, or preferably from about 0 to about 0.5, or more preferably from about 0 to about 0.4; an OH/C ratio from about 0 to 3, or preferably from about 0 to about 2, or more preferably from about 0 to about 1.5; and an O/C ratio from about 0 to 1.7; or preferably from about 0 to about 1.3, or more preferably from about 0 to about 0.8.

### EXAMPLES

### Example 1

Biomass was grounded into 1 mm particles and stored in the storage tank. A homogeneous liquid oil suspended molybdenum disulfide (MoS₂) catalyst was used for the liquefaction of the biomass in the reactor. The biomass was mixed with the catalyst and a recycle oil in the mixer to form a slurry. The concentration of the molybdenum in the slurry was about 1000 ppm. The slurry was pumped into a CSTR reactor. The reactor was operated at a temperature of about 450° C. Hydrogen was also passed to the reactor and 13789 kPag (2000 psig) of hydrogen pressure was maintained with sufficient hydrogen flow. The slurry remained in the reactor for 1-4 hours of residence time. The liquefied product stream was taken from the reactor. The liquefied product stream was fractionated to provide the bio-oil stream. A portion of the bio-oil stream was taken and recycled to the reactor. The other portion was taken as the product bio-oil stream. The product bio-oil stream had an oxygenate concentration of about 10 wt %.

### Examples 2-9

Mixed hardwood or Douglas fir of particle size 1 mm (purchased from Forest Concepts) and catalyst were loaded into either a 500 mL (Examples 2-5) or 300 mL (Examples 6-9) autoclave reactor in a ratio indicated in Table 1 below.

TABLE 1

| | | | | | | | | Press. | | |
|---|---|---|---|---|---|---|---|---|---|---|
| | | | | | | | | (H₂), | | |
| | | Biomass, | | Oil, | | Catalyst, | Oil:Biomass, | MPag | T, | Time, |
| Ex. | Biomass | wt % | Oil | wt % | Catalyst | wt % | wt. ratio | (psig) | ° C. | min. |
| 2 | Mixed | 40 | Fresh | 59.7 | Suspended | 0.3 | 1.5:1 | 13.8 | 450 | 120 |
| | Hardwood | | oil | | MoS₂ in | | | (2000) | | |
| | | | | | Fresh Oil | | | | | |
| 3 | Mixed | 50 | Fresh | 49.8 | Suspended | 0.25 | 1:1 | 13.8 | 450 | 120 |
| | Hardwood | | oil | | MoS₂ in | | | (2000) | | |
| | | | | | Fresh Oil | | | | | |
| 4 | Mixed | 56 | Fresh | 43.8 | Suspended | 0.22 | 0.79:1 | 13.8 | 450 | 120 |
| | Hardwood | | oil | | MoS₂ in | | | (2000) | | |
| | | | | | Fresh Oil | | | | | |
| 5 | Douglas | 70 | Fresh | 29.9 | Suspended | 0.15 | 0.43:1 | 13.8 | 450 | 120 |
| | Fir | | oil | | MoS₂ in | | | (2000) | | |
| | | | | | Fresh Oil | | | | | |
| 6 | Mixed | 57.2 | Fresh | 38.2 | Powder | 4.6 | 0.67:1 | 12.7 | 420 | 120 |
| | Hardwood | | oil | | Ni/W/MoS₂ | | | (1850) | | |
| 7 | Mixed | 58.8 | Fresh | 35.3 | Mo | 5.9 | 0.6:1 | 12.7 | 420 | 120 |
| | Hardwood | | oil | | octoate | | | (1850) | | |
| 8 | Mixed | 60.8 | Recycle | 38.6 | Suspended | 0.65 | 0.63:1 | 12.7 | 420 | 120 |
| | Hardwood | | oil | | MoS₂ in | | | (1850) | | |
| | | | | | Recycle | | | | | |
| | | | | | Oil | | | | | |
| 9 | Mixed | 58.5 | Recycle | 41.2 | Suspended | 0.65 | 0.71:1 | 8.96 | 420 | 120 |
| | Hardwood | | oil | | MoS₂ in | | | (1300) | | |
| | | | | | Recycle | | | | | |
| | | | | | Oil | | | | | |

For examples 2 to 5 and 8 to 9 with suspended MoS₂ catalyst as indicated in Table 1, 0.7-1 mL of dimethyldisulfide was added to help maintain the catalyst in a sulfided form. The autoclave reactor was sealed and pressurized to 1300-2000 psig of H₂ with the H₂ flowing at 420-700 sccm throughout the entirety of the experiment. Subsequently, the autoclave reactor was heated to the temperature as indicated in Table 1 at 2° C./min while stirring at 600-1000 rpm and held at the indicated temperature for 2 hours for Examples 2-9. After the reaction time of 2 hours, the autoclave reactor was cooled to room temperature (20-25° C.). Once cooled, the autoclave reactor was opened and liquid from the reactor was collected. Similarly, a portion of the hydrocarbons became gas at the indicated reaction temperature and were swept out of the reactor via the H₂ flow and were subsequently condensed into liquid in a condenser vessel downstream of the reactor at room temperature. After completion of the experiment, the liquid was drained from the condenser vessel. Additionally, a subset of experiments employed a gas chromatograph (GC) to analyze hydrocarbons that did not condense in the condenser vessel. The total liquid product was considered to be the sum of liquid collected from the autoclave reactor, liquid collected from the condenser vessel, and hydrocarbons of carbon number of at least 5 (C₅₊) detected by the GC, because these C₅₊ hydrocarbons would normally condense to liquid in specifically designed commercial condensers but may not condense in general purpose laboratory condensers. Product distributions from the experiments are given in Table 2. Experiments which include GC analysis are experiments 1, 2, and 3 and these have slightly higher liquid yields due to accounting for the gas phase hydrocarbons. Liquid product yields along with analytical results of the light and heavy oils are given in Table 2.

TABLE 2

| | Ex 2 | Ex 3 | Ex 4 | Ex 5 | Ex 6 | Ex 6 | Ex 8 | Ex 9 |
|---|---|---|---|---|---|---|---|---|
| Total Feed (g) | 180 | 183 | 191 | 105 | 52.4 | 51 | 51 | 54 |
| Liquid Product | 121.1 | 127.2 | 121.2 | 58.0 | 34.1 | 23.7 | 28.4 | 16.4 |
| (g) | | | | | | | | |
| Liquid Product | 67.3 | 69.5 | 63.5 | 55.2 | 65.2 | 46.4 | 55.6 | 30.4 |
| (wt %) | | | | | | | | |

Heavy Oil Product (Stream 137)

| | | | | | | | | |
|---|---|---|---|---|---|---|---|---|
| Relative Density | 0.9702 | 1.0115 | 1.0137 | NM | 0.9038 | NM | NM | NM |
| (g/mL) by D4052 | | | | | | | | |
| Carbon (wt %) by | 86.4 | 87.2 | 82.1 | NM | 85.3 | 88.8 | 85.8 | NM |
| D5291 | | | | | | | | |
| Hydrogen (wt %) | 9.73 | 9.34 | 7.85 | NM | 11.3 | 11.5 | 7.52 | NM |
| by D5291 | | | | | | | | |
| Oxygen (wt %) by | 1.35 | 1.32 | 2.44 | NM | 2.04 | 0.31 | 5.85 | NM |
| U649 | | | | | | | | |
| Oxygen (wt %) by | 3.87 | 3.46 | 10.05 | NM | 3.4 | −0.3 | 6.68 | NM |
| Difference, | | | | | | | | |
| D5291 | | | | | | | | |
| Carboxylic Acid | NM | NM | NM | NM | 2.5 | NM | 0.6 | NM |
| Number (mg | | | | | | | | |
| KOH/g) | | | | | | | | |
| Phenolic Acid | NM | NM | NM | NM | 69.4 | NM | 69.9 | NM |
| Number (mg | | | | | | | | |
| KOH/g) | | | | | | | | |
| NMR | | | | | | | | |
| Spectroscopy | | | | | | | | |
| Aldehydes | 0 | 0 | 0 | 0 | 0 | 0 | 0 | NM |
| (mol % H) | | | | | | | | |
| Ketones, | 0 | 0 | 0 | 0 | 0 | 0 | 0 | NM |
| Aldehydes | | | | | | | | |
| (mol % C) | | | | | | | | |
| Esters, | 0 | 0 | 0 | 0 | 0 | 0 | 0 | NM |
| Carboxylic Acids | | | | | | | | |
| (mol % C) | | | | | | | | |
| Alcohols, Ethers, | 0 | 0 | 0 | 0 | 0 | 0 | 0 | NM |
| Phenyl Methoxy | | | | | | | | |
| Groups, | | | | | | | | |
| Carbohydrates | | | | | | | | |
| (mol % C) | | | | | | | | |
| IR Spectroscopy | | | | | | | | |
| (Band Area Ratio) | | | | | | | | |
| C—O/C | 0.02 | 0.03 | 0.03 | NM | 0.01 | 0.01 | 0.09 | NM |
| C═O/C | 0.01 | 0.02 | 0.02 | NM | 0.01 | 0.01 | 0.03 | NM |
| OH/C | 0.02 | 0.05 | 0.06 | NM | 0.01 | 0.01 | 0.30 | NM |
| O/C | 0.03 | 0.04 | 0.05 | NM | 0.02 | 0.03 | 0.13 | NM |

Light oil Product (Stream 139)

| | | | | | | | | |
|---|---|---|---|---|---|---|---|---|
| Relative Density | 0.8507 | 0.7768 | 0.8508 | NM | NM | 0.8428 | NM | NM |
| (g/ml) by D4052 | | | | | | | | |
| Carbon (wt %) by | 81.8 | 82.6 | 82.2 | 79.6 | 82.8 | 81.5 | 81.1 | 79.5 |
| D5291 | | | | | | | | |
| Hydrogen (wt %) | 12 | 11.9 | 12 | 10.9 | 12.1 | 12.3 | 11.2 | 9.65 |
| by D5291 | | | | | | | | |
| Oxygen (wt %) by | 3.34 | 2.87 | 3.58 | 4.65 | 5.07 | 4.83 | 2.69 | 9.72 |
| U649 | | | | | | | | |
| Oxygen (wt %) by | 6.2 | 5.5 | 5.8 | 9.5 | 5.1 | 6.2 | 7.7 | 10.85 |
| Difference, | | | | | | | | |
| D5291 | | | | | | | | |
| Carboxylic Acid | NM | NM | NM | NM | 18.0 | 38.7 | NM | 23.7 |
| Number (mg | | | | | | | | |
| KOH/g) | | | | | | | | |
| Phenolic Acid | NM | NM | NM | NM | 51.4 | 37.6 | NM | 154.9 |
| Number (mg | | | | | | | | |
| KOH/g) | | | | | | | | |
| NMR | | | | | | | | |
| Spectroscopy | | | | | | | | |
| Aldehydes | 0 | 0 | 0 | NM | 0 | 0.05 | 0.06 | 0.02 |
| (mol % H) | | | | | | | | |
| Ketones, | 0.55 | 0.71 | 0.68 | NM | 2.03 | 2.82 | 1.75 | 0.93 |
| Aldehydes | | | | | | | | |
| (mol % C) | | | | | | | | |
| Esters, | 0.28 | 0.22 | 0.33 | NM | 2.58 | 1.72 | 0.74 | 0.61 |
| Carboxylic Acids | | | | | | | | |
| (mol % C) | | | | | | | | |
| Alcohols, Ethers, | 0.37 | 0.49 | 0.45 | NM | 5.80 | 6.05 | 5.39 | 4.62 |
| Phenyl Methoxy | | | | | | | | |
| Groups, | | | | | | | | |
| Carbohydrates | | | | | | | | |
| (mol % C) | | | | | | | | |
| IR Spectroscopy | | | | | | | | |
| (Band Area Ratio) | | | | | | | | |
| C—O/C | 0.04 | 0.03 | 0.05 | NM | 0.10 | 0.11 | 0.15 | 0.31 |
| C═O/C | 0.05 | 0.04 | 0.05 | NM | 0.08 | 0.11 | 0.12 | 0.19 |
| OH/C | 0.11 | 0.07 | 0.13 | NM | 0.18 | 0.14 | 0.29 | 0.81 |
| O/C | 0.09 | 0.07 | 0.10 | NM | 0.18 | 0.22 | 0.27 | 0.50 |

*NM = not measured

As evident from Tables 1 and 2, a higher reaction temperature enables a more active catalyst which, in turn, enables a significantly higher concentration of biomass in the feed, a significantly higher deoxygenated and upgraded bio-oil product, and a significantly higher yield of liquid oil product compared to a typical liquefaction process, providing a more economical process. A more active catalyst also enables the recycle of catalyst, in the recycle oil stream, which normally suffers from deactivation and reduced activity in the typical aqueous liquefaction process. Furthermore, the removal of a portion of the used catalyst and addition of fresh catalyst helps to further mitigate any process deactivation and reduced activity.

Acid number of the recycle stream, and the bio-oil stream were measured based on the method as per Dence, C. W. (1992). Determination of Carboxyl Groups. In: Lin, S. Y., Dence, C. W. (eds) Methods in Lignin Chemistry. Springer Series in Wood Science. Springer, Berlin, Heidelberg. p. 458-464. https://doi.org/10.1007/978-3-642-74065-7. The details of the acid number test are as below:

### Materials

0.05N tetra-n-butylammonium hydroxide solution (TnBAH): Prepared by diluting 50.0 mL of 1.0N TnBAH (Aldrich, SAP #1014519, 100 mL) solution to 1.00 L in isopropanol. Components were mixed thoroughly before transferring the solution to a Dosimat bottle. The 1.0N TnBAH solution was blanketed with nitrogen and stored in the refrigerator.

Benzoic Acid: p-Hydroxybenzoic Acid, was stored in a dessicator when not in use.

Hydrochloric Acid additive solution: 2 mL of concentrated HCl was added to 100 mL of deionized water and mixed thoroughly. 4 mL of this solution was added to ˜140 mL of dimethylformamide (DMF) for titration of samples.

### Standardization of the Titrant

0.15-0.20 g of dried benzoic acid was added into a titration beaker and the weight was recorded to the nearest 0.1 mg. 120 mL of DMF was added and titrate with the TnBAH solution. The standardization was done in duplicate. Normality was calculated to 3 significant figures as per the below formula:

$$N = \frac{g Benzoic acid}{( mL titrant ) ( 0.12212 )}$$

Standardization was repeated every 3 hours when using this procedure.

### Titration of Samples

Prior to the first sample analysis, 0.05-0.08 g of p-hydroxybenzoic acid was weighed into a titration beaker. 140 mL of DMF and 4 mL of the HCl additive solution was added. The resultant solution was titrated through the 3rd inflection. This was the blank used to calculate the HCl correction and can be used as a QC for the Phenolic Hydroxyl titrations.

0.3-0.4 g of lignin and 0.05-0.08 g of p-hydroxybenzoic acid were weighed into a titration beaker. 140 mL of DMF and 4 mL of the HCl additive solution were added. Beaker was blanketed with nitrogen and stirred for 5 minutes before titration. Titration was performed with 0.05N TnBAH to the 3rd inflection.

### Calculations

The theoretical titer of the internal standard used was calculated in the blank or sample titration:

$$a ( mL ) = \frac{g pHBA}{0.13812 ( N )}$$

$$HCl interference was calculated from the blank c ( mL ) = [ ( measured volume to reach 2 nd inflection of blank ) - ( measured 1 st inflection ) ] - ( a ( mL , calculated above ) ) , then$$

$$mEq carboxyl / g sample = \frac{[ ( y ) - ( x ) - ( c ) - ( a ) ] N}{w}$$

$$mEq phenolic hydroxyls / g sample = \frac{[ ( z ) - ( y ) - ( a ) ] N}{w}$$

where,
x=mL at first inflection point;
y=mL at second inflection point;
z=mL at third inflection point.

The foregoing method was used to measure acid number typically without use of the p-hydroxybenzoic acid internal standard for expedience. However, use of the internal standard is typically recommended. For acid number, carboxyl acid values were measured in the recycle stream, and the bio-oil stream.

An elemental analysis for oxygen concentration was also performed for the recycle stream, the bio-oil stream and the petroleum VGO stream. The elemental analysis was performed via ASTM method D5291 and ASTM UOP649.

Integrated areas of various 1H and 13C NMR spectral regions of the upgraded bio-oil were measured to calculate the concentration of oxygenate groups. The oxygenate groups and the calculated values are tabulated in Table 2 above. IR spectroscopy band area ratios, CHO, density, and acid number were also measured. As evident from Table 2, the concentration of oxygenates including aldehyde, ketone, and hydroxyl groups were all within the predetermined desired ranges indicating that the upgraded bio-oil product may be recycled, used as fuel as-is, or may be sent for further downstream processing without worry about bio-oil polymerization.

### SPECIFIC EMBODIMENTS

While the following is described in conjunction with specific embodiments, it will be understood that this description is intended to illustrate and not limit the scope of the preceding description and the appended claims.

A first embodiment of the present disclosure is a process for upgrading a biomass feed stream comprising deoxygenating and liquefying the biomass feed stream over a catalyst in the presence of hydrogen in a reactor to produce a reactor effluent stream; separating the reactor effluent stream to provide a liquid effluent stream comprising bio-oil; adding an oil stream to the reactor in an oil to biomass weight ratio of no more than about 0.4:1 to about 1.9:1; and producing a fuel stream from a bio-oil stream taken from the liquid effluent stream. An embodiment of the present disclosure is one, any or all of prior embodiments in this paragraph up through the first embodiment in this paragraph, wherein the reactor comprises less than 50 wt % water. An embodiment of the present disclosure is one, any or all of prior embodiments in this paragraph up through the first embodiment in this paragraph, wherein the oil stream is a recycle oil stream taken from the liquid effluent stream. An embodiment of the present disclosure is one, any or all of prior embodiments in this paragraph up through the first embodiment in this paragraph, wherein the recycle oil stream comprises less than 5 wt % water. An embodiment of the present disclosure is one, any or all of prior embodiments in this paragraph up through the first embodiment in this paragraph, wherein the biomass feed stream is reacted in a slurry reactor. An embodiment of the present disclosure is one, any or all of prior embodiments in this paragraph up through the first embodiment in this paragraph further comprising operating the slurry reactor at a pressure of about 6890 kPag to about 17240 kPag. An embodiment of the present disclosure is one, any or all of prior embodiments in this paragraph up through the first embodiment in this paragraph further comprising operating the slurry reactor at a temperature of about 300° C. to about 500° C. An embodiment of the present disclosure is one, any or all of prior embodiments in this paragraph up through the first embodiment in this paragraph, wherein the catalyst comprises one or more Group VIB metals. An embodiment of the present disclosure is one, any or all of prior embodiments in this paragraph up through the first embodiment in this paragraph, wherein the catalyst is a sulfided catalyst. An embodiment of the present disclosure is one, any or all of prior embodiments in this paragraph up through the first embodiment in this paragraph further comprising mixing the biomass feed stream, the catalyst and the oil stream to provide a mixed stream; and passing the mixed stream to the reactor. An embodiment of the present disclosure is one, any or all of prior embodiments in this paragraph up through the first embodiment in this paragraph, wherein the bio-oil stream comprises less than about 20 wt % oxygenates. An embodiment of the present disclosure is one, any or all of prior embodiments in this paragraph up through the first embodiment in this paragraph, wherein the upgraded bio-oil comprises at least one or more of an aldehyde at a concentration of about 0 mol % H to about 4 mol % H, at least one of the group ketones and aldehydes at a concentration of about 0 mol % C to about 6 mol % C, at least one of the group carboxylic acids and esters at a concentration of about 0 mol % C to about 6 mol % C, at least one of the group ethers, alcohols, phenyl methoxy groups, and carbohydrates at a concentration of about 0 mol % C to about 11 mol % C. An embodiment of the present disclosure is one, any or all of prior embodiments in this paragraph up through the first embodiment in this paragraph, wherein the upgraded bio-oil comprises a ratio of oxygenates of one or more of a (C—O)/C ratio from about 0 to about 0.7, a (CO)/C ratio from about 0 to about 0.6, an OH/C ratio from about 0 to 3, and an O/C ratio from about 0 to 1.7. An embodiment of the present disclosure is one, any or all of prior embodiments in this paragraph up through the first embodiment in this paragraph, wherein the oxygenate comprises one or more of an aldehyde, a ketone, an ester, an ether, phenolics, and an organic acid. An embodiment of the present disclosure is one, any or all of prior embodiments in this paragraph up through the first embodiment in this paragraph further comprising separating water from the reactor effluent stream to provide the liquid effluent stream; and taking the oil stream from the liquid effluent stream.

A second embodiment of the present disclosure is a process for upgrading a biomass feed stream comprising deoxygenating and liquefying a biomass feed stream over a catalyst in the presence of hydrogen in a reactor to produce a reactor effluent stream, wherein said biomass feed stream is charged into the reactor at a volumetric rate to provide a liquid hourly space velocity between about 0.1 hr⁻¹ to about 1.0 hr⁻¹; separating the reactor effluent stream to provide a liquid effluent stream comprising bio-oil; adding an oil stream to the reactor in an oil to biomass weight ratio of no more than about 1.5:1, wherein the oil stream comprises less than 5 wt % water; and separating a bio-oil stream from the liquid effluent stream to produce a fuel stream. An embodiment of the present disclosure is one, any or all of prior embodiments in this paragraph up through the second embodiment in this paragraph, wherein the oil stream is a recycle oil stream taken from the liquid effluent stream. An embodiment of the present disclosure is one, any or all of prior embodiments in this paragraph up through the second embodiment in this paragraph, wherein the biomass feed stream is reacted in a slurry reactor. An embodiment of the present disclosure is one, any or all of prior embodiments in this paragraph up through the second embodiment in this paragraph further comprising operating the slurry reactor at a pressure of about 6890 kPag to about 17240 kPag. An embodiment of the present disclosure is one, any or all of prior embodiments in this paragraph up through the second embodiment in this paragraph further comprising operating the slurry reactor at a temperature of about 300° C. to about 500° C. An embodiment of the present disclosure is one, any or all of prior embodiments in this paragraph up through the second embodiment in this paragraph further comprising separating water from the reactor effluent stream to provide the liquid effluent stream comprising bio-oil; and taking the oil stream from the liquid effluent stream.

A third embodiment of the present disclosure is a process for upgrading a biomass feed stream comprising deoxygenating and liquefying a biomass feed stream over a catalyst comprising one or more Group VIB metals, in the presence of hydrogen in a reactor to produce a reactor effluent stream; separating water from the reactor effluent stream to provide a liquid effluent stream comprising bio-oil; adding an oil stream to the reactor in an oil to biomass weight ratio of no more than about 1.5:1; separating a bio-oil stream from the liquid effluent stream; and producing a fuel stream from the bio-oil stream.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing. all temperatures are set forth in degrees Celsius and. all parts and percentages are by weight, unless otherwise indicated.

1. A process for upgrading a biomass feed stream comprising:
deoxygenating and liquefying said biomass feed stream over a catalyst in the presence of hydrogen in a reactor to produce a reactor effluent stream;
separating said reactor effluent stream to provide a liquid effluent stream comprising bio-oil;
adding an oil stream to the reactor in an oil to biomass weight ratio of no more than about 0.4:1 to about 1.9:1; and
producing a fuel stream from a bio-oil stream taken from said liquid effluent stream.

2. The process of claim 1, wherein the reactor comprises less than 50 wt % water.

3. The process of claim 1, wherein said oil stream is a recycle oil stream taken from said liquid effluent stream.

4. The process of claim 3, wherein said recycle oil stream comprises less than 5 wt % water.

5. The process of claim 1, wherein said biomass feed stream is reacted in a slurry reactor.

6. The process of claim 1, wherein the catalyst comprises one or more Group VIB metals.

7. The process of claim 1, wherein the catalyst is a sulfided catalyst.

8. The process of claim 1 further comprising:
mixing said biomass feed stream, the catalyst and said oil stream to provide a mixed stream; and
passing said mixed stream to the reactor.

9. The process of claim 1, wherein said bio-oil stream comprises less than about 20 wt % oxygenates.

10. The process of claim 1, wherein the upgraded bio-oil comprises at least one or more of an aldehyde at a concentration of about 0 mol % H to about 4 mol % H, at least one of the group ketones and aldehydes at a concentration of about 0 mol % C to about 6 mol % C, at least one of the group carboxylic acids and esters at a concentration of about 0 mol % C to about 6 mol % C, at least one of the group ethers, alcohols, phenyl methoxy groups, and carbohydrates at a concentration of about 0 mol % C to about 11 mol % C.

11. The process of claim 1, wherein the upgraded bio-oil comprises a ratio of oxygenates of one or more of a (C—O)/C ratio from about 0 to about 0.7, a (C═O)/C ratio from about 0 to about 0.6, an OH/C ratio from about 0 to 3, and an O/C ratio from about 0 to 1.7.

12. The process of claim 11, wherein the oxygenate comprises one or more of an aldehyde, a ketone, an ester, an ether, phenolics, and an organic acid.

13. The process of claim 1 further comprising:
separating water from said reactor effluent stream to provide said liquid effluent stream; and
taking said oil stream from said liquid effluent stream.

14. A process for upgrading a biomass feed stream comprising:
deoxygenating and liquefying a biomass feed stream over a catalyst in the presence of hydrogen in a reactor to produce a reactor effluent stream, wherein said biomass feed stream is charged into the reactor at a volumetric rate to provide a liquid hourly space velocity between about 0.1 hr⁻¹ to about 1.0 hr⁻¹;
separating said reactor effluent stream to provide a liquid effluent stream comprising bio-oil;
adding an oil stream to the reactor, wherein the oil stream comprises less than 5 wt % water; and
separating a bio-oil stream from said liquid effluent stream to produce a fuel stream.

15. The process of claim 14, wherein said oil stream is a recycle oil stream taken from said liquid effluent stream.

16. The process of claim 14, wherein said biomass feed stream is reacted in a slurry reactor.

17. The process of claim 16 further comprising operating said slurry reactor at a pressure of about 6890 kPa to about 17240 kPa.

18. The process of claim 16 further comprising operating said slurry reactor at a temperature of about 300° C. to about 500° C.

19. The process of claim 14 further comprising:
separating water from said reactor effluent stream to provide said liquid effluent stream comprising bio-oil; and
taking said oil stream from said liquid effluent stream.

20. A process for upgrading a biomass feed stream comprising:
deoxygenating and liquefying a biomass feed stream over a catalyst comprising one or more Group VIB metals, in the presence of hydrogen in a reactor to produce a reactor effluent stream;
separating water from said reactor effluent stream to provide a liquid effluent stream comprising bio-oil;
adding an oil stream to the reactor in an oil to biomass weight ratio of no more than about 1.5:1;
separating a bio-oil stream from said liquid effluent stream; and
producing a fuel stream from said bio-oil stream.
